(19) United States
(12) Patent Application Publication
(10) Pub. No.: US 2008/0074386 A1
(43) Pub. Date: Mar. 27, 2008

(54) Virtual input device and the input method thereof

(76) Inventors: Chia-Hoang Lee, Chunan (TW); Jian-Liang Lin, Tainan City (TW); Ming-Chao Huang, Taipei (TW)

Correspondence Address: REED SMITH LLP, Suite 1400, 3110 Fairview Park Drive, Falls Church, VA, 22042, US

(21) Appl. No.: 11/902,203

(22) Filed: Sep. 19, 2007

(30) Foreign Application Priority Data
Sep. 27, 2006 (TW) 095135672

(51) Int. Cl. G06F 3/00; G06F 3/033

(52) U.S. Cl. 345/156; 345/168

(57) ABSTRACT

This invention provides a virtual input device. The virtual input device comprises an image device, a tip generation module, a display with an input interface and an inputted message area, a transformation device and a key-press determination device, wherein the input interface includes a first button corresponding to a first value, etc. The image device captures a plurality of environmental images based on the movement of a real object such as fingertip. The tip generation module, corresponding to the plurality of environmental images, generates a tip position parameter. The transformation device generates a virtual object on the input interface based on the tip position parameter. The key-press determination device selectively generates the first value on the inputted message area based on a set of virtual parameter of the virtual object.

### BACKGROUND OF THE INVENTION

1. Field of the Invention

This invention relates to an information input device and a method thereof and, more particularly, to a display apparatus which is equipped with an image capturing device for inputting data without a real keyboard.

2. Description of the Prior Art

In many electronic apparatuses, information input devices provide an interaction interface for users to communicate with the electronic apparatuses. In general, electronic apparatuses like computers and mobile phones all provide a real keyboard 10 (as shown in FIG. 1, the real keyboard can include keys of both alphabets and numbers) for users to input information. In addition, some electronic apparatuses provide touch panels which each displays a virtual keyboard, and when a user actually touches the virtual keyboard, the corresponding input information will be generated.

Regardless of a real keyboard or a virtual keyboard of a touch panel, a user must contact the keyboard or the virtual keyboard of a touch panel by fingers or real objects like a touch pen, so as to enable the electronic apparatuses to determine what kind of data is inputted by the user.

However, this kind of touched-input interface often has some problems. For example, dozens of keys are contained in a mobile phone or a PDA keyboard, they will increase the volume of the mobile phone or the PDA, and make them inconvenient to be carried and relatively increase manufacturing costs, too. Moreover, constantly repeating the password with fingers or abrasions on the keyboard may allow malefactors to easily find the passwords. Besides, the touched-input interface easily causes health problems. For example, an auto telling machine is operated by several hundreds of people everyday, and the touches on the keys in operations may be a transmitting route of viruses or bacteria.

In the light of the above-mentioned defects, many non-touch virtual keyboards are disclosed to solve related problems. For example, U.S. Pat. No. 5,767,842 first projects a virtual optical keyboard on a real plane, and then uses an optical sensor to detect the contacting situation between user's fingers and the virtual optical keyboard, so as to determine whether the user presses specific keys. The defect of this resolution is that it requires a real plane for the optical system to project the virtual optical keyboard. Another kind of non-touch virtual keyboard is seen in U.S. Pat. No. 6,388,657, and the system lets a user wear a display helmet and a glove. The display helmet is for displaying virtual images which include objects such as keyboard, and the glove thereon is configured with several sensors for detecting moving situation of the user's fingers, so as to determine whether the user presses specific keys. The defect of this resolution is that it requires a display helmet and a sensing glove, and the cost of the resolution is relatively high and it is inconvenient to carry.

Accordingly, the invention provides a virtual input device. In one aspect, the virtual input device allows a user to input information without a real keyboard. In another aspect, the virtual input device allows a user to input data in space at will. Still in another aspect, the virtual input device does not need complicated devices, and data can be inputted by a common image capturing apparatus and a display device.

### SUMMARY OF THE INVENTION

A scope of the invention is to provide a virtual input device for a user to input information by using common display devices which are equipped with image capturing apparatuses without the assistance of a real keyboard.

A scope of the invention is to provide a non-touch input device for users to input data in space at will without touching any real apparatuses.

Another scope of the invention is to provide a hand-held device (such as a mobile phone or a PDA) for inputting information through the image capturing apparatus and the display of the hand-held device. The manufacturing cost of the hand-held device will be reduced.

Another scope of the invention is to provide a security input device (such as an access control system or a drawing system) that allows users to input keywords or related security information in the air without touching any real keyboard or touch panel.

According to a preferred embodiment, the virtual input device of the invention includes an image capturing device, a tip generation module, a display which includes an input interface, a transformation device, and a key-press determination device, wherein the input interface includes a first input key which corresponds to a first input value. The image capturing device is used for capturing a plurality of environmental images based on the movement of a real object; the tip generation module generates a tip position parameter according to the plurality of environmental images; the transformation device generates a virtual object on the input interface according to the tip position parameter; the key-press determination device is used for selectively generating the first input value in the message line according to a set of virtual parameters of the virtual object. Therefore, users can input information by using the invention to input information without the assistance of a real keyboard.

Another scope of the invention is to provide an information inputting method which includes the steps of (a) displaying an input interface which includes a first input key that corresponds to a first input value and a message line on a screen; (b) capturing a plurality of environmental images responding to the motion of a real object; (c) generating a tip position parameter according to the plurality of environmental images; (d) generating a virtual object on the input interface according to the tip position parameter; and (e) selectively generating the first input value in the message line according to a set of virtual parameters of the virtual object.

The advantage and spirit of the invention may be understood by the following recitations together with the appended drawings.

### BRIEF DESCRIPTION OF THE APPENDED DRAWINGS

FIG. 1 is a schematic diagram illustrating a real keyboard of prior arts.

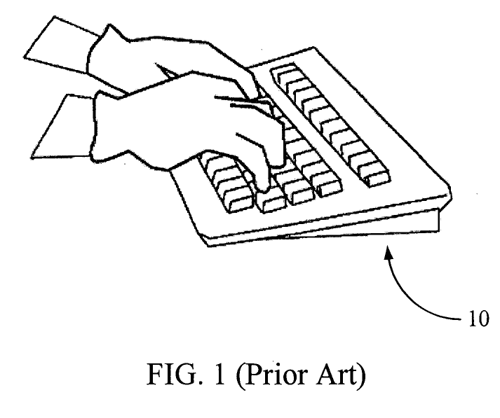

FIG. 2 is a block diagram illustrating the virtual input device of an embodiment of the invention.

FIG. 3 is a block diagram of the tip generating module in FIG. 2.

FIG. 4A is a block diagram of the object detecting module in FIG. 3.

FIG. 4B is a flow chart diagram of the distinguishing device and the first error deleting device in FIG. 4A.

FIG. 5A is a block diagram of the relative motion device in FIG. 3.

FIG. 5B is a flow chart diagram of the camera vibrated device and the second error deleting device in FIG. 5A.

FIG. 6 is a schematic diagram illustrating a practical application of the virtual input device in FIG. 2.

### DETAILED DESCRIPTION OF THE INVENTION

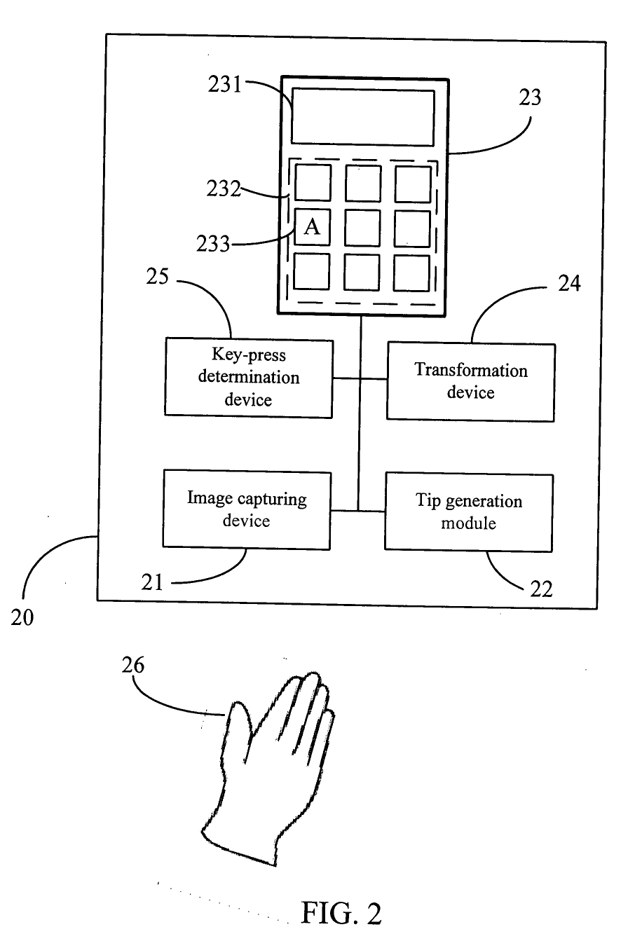

Please refer to FIG. 2. FIG. 2 is a block diagram illustrating the virtual input device 20 of an embodiment of the invention. The virtual input device 20 includes an image capturing device 21, a tip generation module 22, a display 23, a transformation device 24, and a key-press determination device 25. The display 23 can display an input interface 232 and a message line 231, and the input interface 232 can be common numerical keys or further includes a plurality of alphabetical keys, wherein the input interface 232 includes at least a first input key 233 which corresponds to a first input value.

The image capturing device 21 can be a CCD image capturing device or a CMOS image capturing device. The image capturing device 21 is for capturing a plurality of environmental images based on the movement of a real object, and the real object can be the users' fingers or any object having tips, such as a ball-point pen. When a user's finger or a ball-point pen moves, the image capturing device 21 can capture a plurality of environmental images which include the real object.

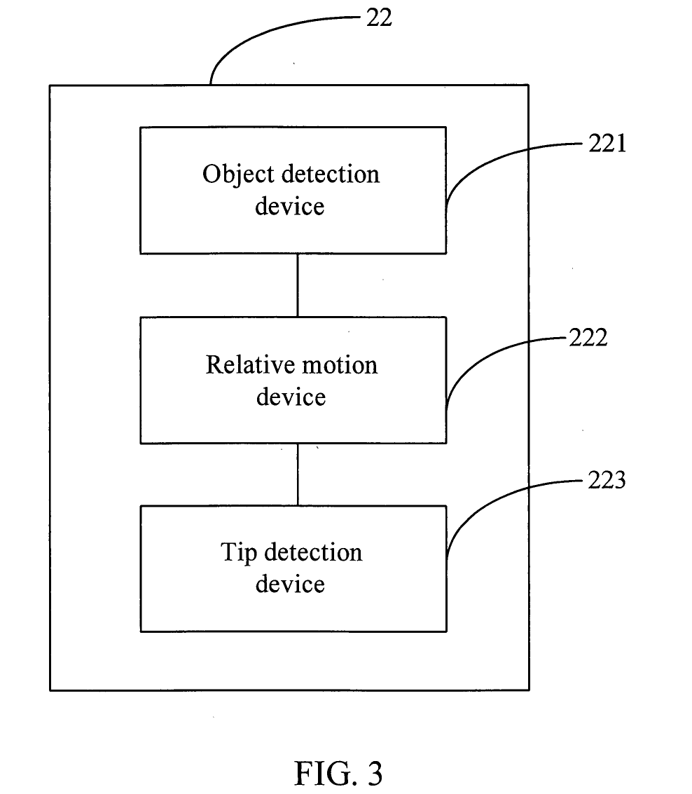

The tip generation module 22 generates a tip position parameter according to the plurality of environmental images. That is to say, the tip generation module 22 determines moving or still situation of the tip of the real object within the plurality of environmental images. Referring to FIG. 3, in an embodiment, the tip generation module 22 includes an object detection device 221, a relative motion device 222, and a tip detection device 223. Wherein, the object detection device 221 detects an area which contains the real object within the plurality of environmental images, so as to generate a set of object images. That is to say, the object detection device 221 can reject non-entities within the plurality of environmental images as much as possible, so as to let the set of object images include most messages which are related to the real object.

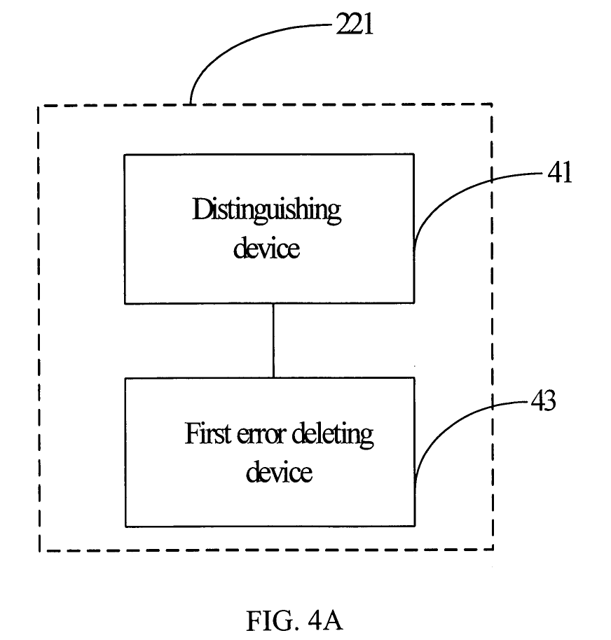

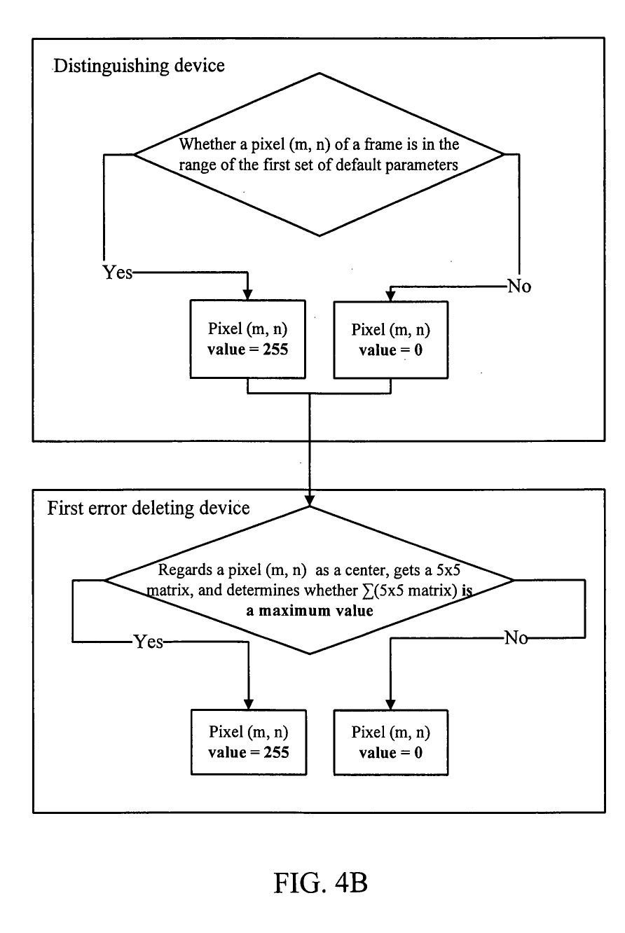

Please refer to FIG. 4A. The object detection device 221 can include a distinguishing device 41 and a first error deleting device 43. The distinguishing device 41 is for generating a set of temporary object images according to the plurality of environmental images and a first set of default parameters. The first error deleting device 43 is used for generating the set of object images according to the set of temporary object images and a second set of default parameters. Referring to FIG. 4B, in an embodiment, when the real object is a finger of a user, the first set of default parameters can be the range of the skin colors of the finger. If the value of a pixel of (i)-th frame within the plurality of environmental images is within the range of the first set of default parameters, the distinguishing device 41 can set the value of the pixel as 255. On the contrary, the value of the pixel can be set as 0. So, after being processed for several times, the position of the finger within every frame can be marked, so as to generate the set of temporary object images. Moreover, because the colors of other small objects within the ambient environment are close to that of the finger, the small objects can be deleted for reducing errors. The first error deleting device 43 calculates every frame of the set of temporary images one by one and deletes the small objects with colors too close to that of the finger from the set of temporary images to derive the set of object images. In an embodiment, the second error deleting device includes a matrix and a maximum value. Referring to FIG. 4B, the first error deleting device 43 regards a pixel (m, n) of (i)-th frame as a center, gets a 5×5 matrix (i.e. pixel (m−2, n−2) to pixel (m+2, n+2)), and executes addition operation of the 25 pixels, and if the added value is equal to or larger than the maximum value, the first error deleting device 43 determines the pixel (m, n) to be a part of the finger and still sets the value of the pixel as 255. On the contrary, the pixel (m, n) will not be determined as a part of the finger, and the value of the pixel will be set as 0. After processing every pixel of every frame within the set of temporary object images, the first error deleting device 43 will generates the set of object images. Certainly, the matrix and the maximum value can be adjusted according to realistic situation.

The relative motion device 222 generates a set of relative motion images according to the set of object images. When the image capturing device 21 is fixed without shaking (such as the cash dispensers in common banks are all equipped with video cameras that won't shake), the relative motion device 222 can continuously retrieve and compare two adjacent object images of the set of object images to generate the set of relative motion images. For example, the set of object images include (i)-th frame and (i-1)-th frame, and after executing subtracting operation or addition operation of (i)-th frame and (i-1)-th frame, the motion information of the real object within the set of object images will be derived on one part, and the reduction of effective data amount caused by executing subtracting operation or addition operation of (i)-th frame and (i-1)-th frame will help accelerating follow-up image processing on the other part.

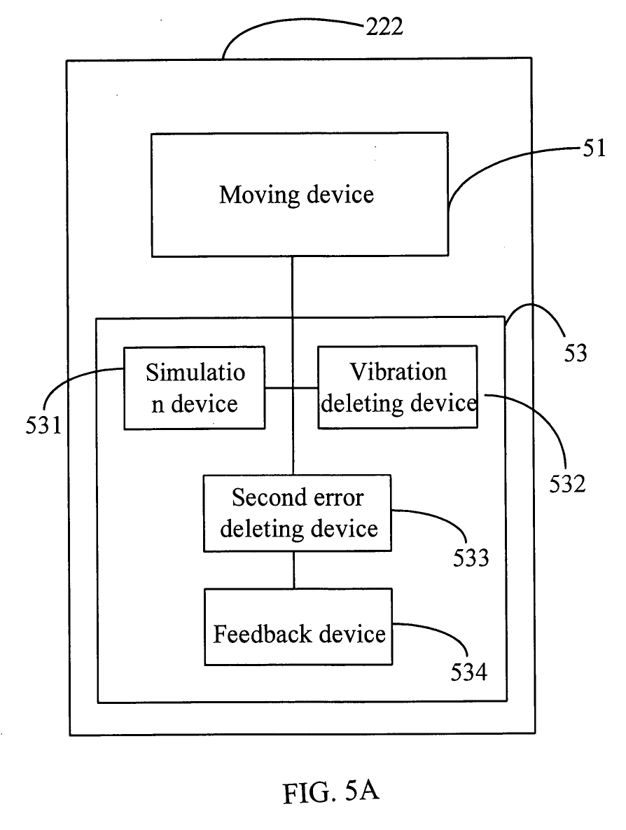

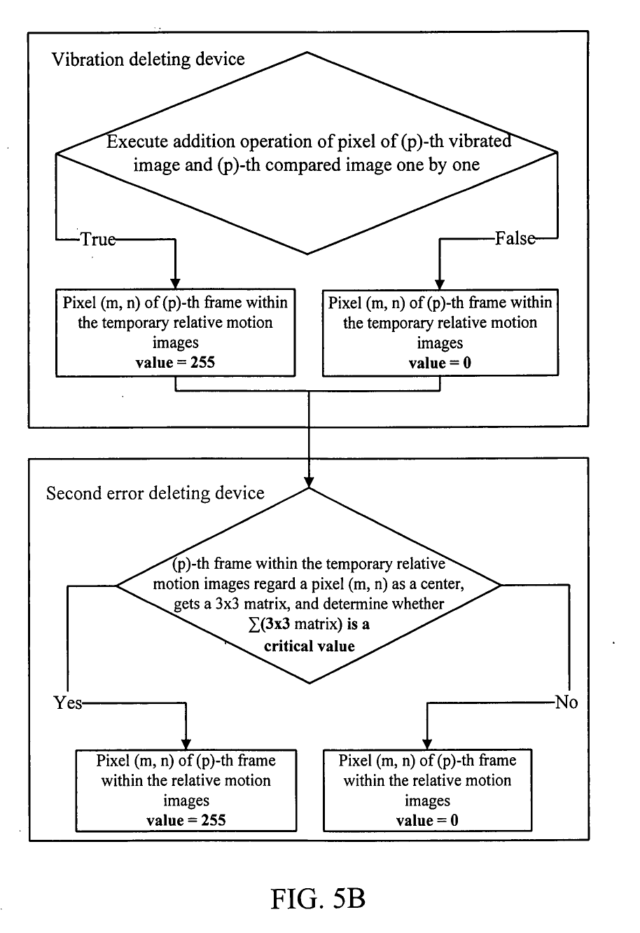

Please refer to FIG. 5A. In another embodiment, when the moving of image capturing device 21 causes shaking, the relative motion device 222 includes a moving device 51 and a vibration device 53. The moving device 51 continuously retrieves and executes subtracting operation or addition operation to two adjacent object images from the set of object images to generate a set of compared images. That is to say, the current moving device 51 is similar to the relative motion device 222 of the above-mentioned embodiment (the image capturing device 21 is fixed without shaking). The vibration device 53 receives the set of compared images and the plurality of environmental images to generate the set of relative motion images. The moving of the image capturing device 21 comes with the possibility of shaking. In order to reduce the error caused by shaking, the vibration device 53 can reject factors of vibration from the image capturing device 21 as much as possible. The vibration device 53 includes a simulation device 531, a vibration deleting device 532, and a second error deleting device 533. In an embodiment, the simulation device 531 can generate a set of camera vibrated images according to the plurality of environmental images. For example, the plurality of environmental images include (i)-th frame and (i-1)-th frame, and the simulation device 531 can use the simulation of executing the subtracting operation or additional operation of (i)-th frame and (i-1)-th frame which employs a small displacement to generate the set of camera vibrated images.

The vibration deleting device 532 is for generating a set of temporary relative motion images according to the set of camera vibrated images and the set of compared images. As mentioned above, the plurality of environmental images include (i)-th frame and (i-1)-th frame, and the simulation device 531 can use the simulation of executing the subtracting operation or additional operation of (i)-th frame and (i-1)-th frame which employs a small displacement to generate (p)-th vibrated images. At the same time, the moving device 51 includes (i)-th frame and (i-1)-th frame and executes subtracting operation or addition operation of (i)-th frame and (i-1)-th frame to generate (p)-th compared images. Please refer to FIG. 5A. The vibration deleting device 522 executes subtracting operation or additional operation of (p)-th vibrated image and (p)-th compared image, and if the addition value of the pixel (m, n) of (p)-th vibrated image and the pixel (m, n) of (p)-th compared image are true, the value of the pixel (m, n) of (p)-th frame of the set of temporary relative motion images will be set as 255. If on the contrary, it will then be set as 0. After repeating the process several times, the set of temporary relative motion images can be generated.

In order to delete errors, the second error deleting device 533 is used for generating the set of relative motion images according to the set of temporary motion images and a third set of default parameters. In an embodiment, the third set of default parameters includes a matrix and a critical value. Please refer to FIG. 5B. The second error deleting device 533 regards a pixel (m, n) of (i)-th frame of the set of temporary relative motion images as a center, gets a 3×3 matrix (i.e. pixel (m−1, n−1) to pixel (m+1, n+1)), and executes addition operation of the 9 pixels, and if the added value is equal to the critical value, the second error deleting device 533 sets the value of the pixel as 255. If on the contrary, the value of the pixel will be set as 0. After processing every pixel of every frame within the set of temporary relative motion images, the set of relative motion images will be generated.

Please refer to FIG. 5. In order to increase the stability of the system, the vibration device 53 further includes a feedback device 534 which generates a set of feedback parameters according to the set of relative motion images, so as to selectively amend the second set of default parameters, the third set of default parameters and the pre-determined displacement which is set by the simulation device 531. And the selected matrix, the critical value, the maximum value, and the pre-determined displacement will be amended to reduce the errors of the system.

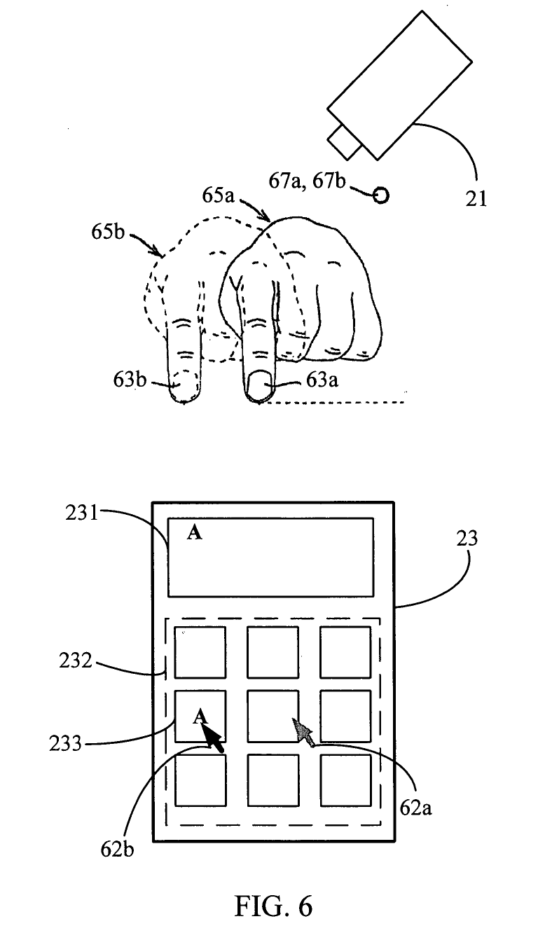

The tip detection device 223 determines an area which contains a first tip of the real object within the set of relative motion images, so as to generate the tip position parameter. For example, the tip detection device 223 can determines the region of finger tips within the set of relative motion images, so as to store the message of the position or the moving situation of the finger tips into the tip position parameter. The transformation device 24 generates a virtual object on the input interface according to the tip position parameter. Referring to FIG. 6, after the transformation device 24 receiving the tip position parameter, a virtual object will be generated on the virtual keyboard on the display 23. If a user finds that the virtual object is not at the key the user wants to touch, the user can actually move a finger from position 63a to position 63b, and relatively the virtual object will move from position 62a to position 62b until the virtual object overlaps the first input key 233 observed by the user through the display 23.

Please refer to FIG. 6. The input interface 232 which is displayed by the display 23 includes a first input key 233 which corresponds to a first input value. The display 23 further includes a message line 231 to display inputted information. The key-press determination device 25 is used for selectively generating the first input value in the message line 231 according to a set of virtual parameters of the virtual object. For example, the virtual parameter includes an overlapping time 233 of the virtual object and the first input value, and the key-press determination device 25 generates the first input value in the message line 231 when the overlapping time is larger than a default time value. In other words, when the stationary time of the virtual object and the first input key 233 is larger than a default time value, the first input value which the user wants to input can be determined, such that the key-press determination device 25 generates the first input value in the message line 231 for the user to know what the inputted information is. Other than determining according to the stationary time, a determining method that determines whether the virtual object presses the first input key 233 can be used. At this time, the virtual parameter includes a set of moving parameters of the virtual object corresponding to the first input key 233 during a first time, and the key-press determination device generates the first input value in the message line 231 when the set of moving parameters complies with a default key-press condition.

According to the above-mentioned explanations, the image capturing device 21 can capture moving images, and the tip generation module can process the tip position or the moving situation of the finger or a pen, and a virtual finger (i.e. virtual object) will be generated on the input interface of the display by the transformation device. When the virtual finger stays at a specific key for a certain time or presses the specific key, the key-press determination device will display the result in the message line of the display. The user can observe the position of the virtual finger and the display 23 to move finger by himself and moves the virtual object to the specific key on the input interface. Therefore, the user can input information by using the invention without the assistance of a real keyboard.

The invention also provides an information inputting method which includes the steps of: (a) displaying an input interface, which includes a first input key corresponding to a first input value, on a screen; (b) capturing a plurality of environmental images responding to the motion of a real object; (c) generating a tip position parameter according to the plurality of environmental images; and (d) generating a virtual object on the input interface according to the tip position parameter.

The step of generating the tip position parameter includes the steps of: (c1) detecting an area containing the real object within the plurality of environmental images, so as to generate a set of object images; (c2) generating a set of relative motion images according to the set of object images; and (c3) determining an area containing a first tip of the real object within the set of relative motion images, so as to generate the tip position parameter. Wherein, the step (c1) includes the steps of: (c11) generating a set of temporary object images according to the plurality of environmental images and a first set of default parameters; and (c12) generating the set of object images according to the set of temporary object images and a second set of default parameters.

When the image capturing device 21 is fixed without shaking, the step (c2) continuously retrieves and compares two adjacent object images from the set of the object images to generate the set of relative motion images. But if the moving of the image capturing device 21 causes shaking, the step (c2) includes the steps of: (c21) continuously retrieving and comparing two adjacent object images of the set of the object images to generates a set of compared images; and (c22) generating the set of relative motion images according to the set of compared images and the plurality of environmental images. Wherein, the step (c22) includes the steps of: (c221) generating a set of camera vibrated images according to the plurality of environmental images; (c222) generating a set of temporary relative motion images according to the set of camera vibrated images and the set of compared images; (c223) generating the set of relative motion images according to the set of temporary motion images and a third set of default parameters, and (c224) generating a set of feedback parameters according to the set of relative motion images, so as to selectively amend the second set of default parameters and the third set of default parameters.

In step (e), the virtual parameter can include an overlapping time of the virtual object and the first input key, when the overlapping time is larger than a default time value, the first input value is generated in the message line. Moreover, the step (e) can also use a determining way that determines whether the virtual object presses the first input key. At this time, the virtual parameter includes a set of moving parameters of the virtual object corresponding to the first input key during a first time, and when the set of moving parameters complies with a default key-press condition, the key-press determination device generates the first input value in the message line

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A virtual input device, comprising:
an image capturing device for capturing a plurality of environmental images based on the movement of a real object;
a tip generation module generating a tip position parameter according to the plurality of environmental images;
a display comprising an input interface; and
a transformation device generating a virtual object on the input interface according to the tip position parameter.

2. The virtual input device of claim 1, wherein the tip generation module comprises:
an object detection device detecting an area containing the real object within the plurality of environmental images, so as to generate a set of object images;
a relative motion device generating a set of relative motion images according to the set of object images; and
a tip detection device determining an area containing a first tip of the real object within the set of relative motion images, so as to generate the tip position parameter.

3. The virtual input device of claim 2, the object detection device comprising:
a distinguishing device for generating a set of temporary object images according to the plurality of environmental images and a first set of default parameters; and
a first error deleting device for generating the set of object images according to the set of temporary object images and a second set of default parameters.

4. The virtual input device of claim 3, wherein the relative motion device continuously retrieves and compares two adjacent object images of the set of object images to generate the set of relative motion images.

5. The virtual input device of claim 3, wherein the relative motion device comprises:
a moving device continuously retrieving and comparing two adjacent object images of the set of object images to generate a set of compared images; and
a vibration device receiving the set of compared images and the plurality of environmental images to generate the set of relative motion images.

6. The virtual input device of claim 5, wherein the vibration device comprises:
a simulation device generating a set of camera vibrated images according to the plurality of environmental images;
a vibration deleting device for generating a set of temporary relative motion images according to the set of camera vibrated images and the set of compared images; and
a second error deleting device for generating the set of relative motion images according to the set of temporary motion images and a third set of default parameters.

7. The virtual input device of claim 6, wherein the vibration device further comprises a feedback device generating a set of feedback parameters according to the set of relative motion images, so as to selectively amend the second set of default parameters and the third set of default parameters.

8. The virtual input device of claim 1, the input interface comprising a first input key corresponding to a first input value, the display comprising a message line, wherein the virtual input device further comprises a key-press determination device for selectively generating the first input value in the message line according to a set of virtual parameters of the virtual object.

9. The virtual input device of claim 8, the set of virtual parameters comprising an overlapping time of the virtual object and the first input key, and the key-press determination device generating the first input value in the message line when the overlapping time is larger than a default time value.

10. The virtual input device of claim 8, wherein the set of virtual parameters comprises a set of moving parameters of the virtual object corresponding to the first input key during a first time, and when the set of moving parameters complies with a default key-press condition, the key-press determination device generating the first input value in the message line.

11. An information inputting method comprising the steps of:
(a) displaying an input interface on a screen;
(b) capturing a plurality of environmental images responding to the motion of a real object;
(c) generating a tip position parameter according to the plurality of environmental images; and
(d) generating a virtual object on the input interface according to the tip position parameter.

12. The information inputting method of claim 11, wherein the step (c) comprises the steps of:
(c1) detecting an area containing the real object within the plurality of environmental images, so as to generate a set of object images;
(c2) generating a set of relative motion images according to the set of object images; and
(c3) determining an area containing a first tip of the real object within the set of relative motion images, so as to generate the tip position parameter.

13. The information inputting method of claim 12, wherein the step (c1) comprises the steps of:
(c11) generating a set of temporary object images according to the plurality of environmental images and a first set of default parameters; and
(c12) generating the set of object images according to the set of temporary object images and a second set of default parameters.

14. The information inputting method of claim 13, wherein the step (c2) continuously retrieves and compares two adjacent object images from the set of the object images to generate the set of relative motion images.

15. The information inputting method of claim 13, wherein the step (c2) comprises the steps of:
(c21) continuously retrieving and comparing two adjacent object images of the set of the object images to generate a set of compared images; and
(c22) generating the set of relative motion images according to the set of compared images and the plurality of environmental images.

16. The information inputting method of claim 15, wherein the step (c22) comprises the steps of:
(c221) generating a set of camera vibrated images according to the plurality of environmental images;
(c222) generating a set of temporary relative motion images according to the set of camera vibrated images and the set of compared images; and
(c223) generating the set of relative motion images according to the set of temporary motion images and a third set of default parameters.

17. The information inputting method of claim 16, wherein the step (c22) further comprises the step of:
(c224) generating a set of feedback parameters according to the set of relative motion images, so as to selectively amend the second set of default parameters and the third set of default parameters.

18. The information inputting method of claim 11, the input interface comprising a first input key corresponding to a first input value, the display comprising a message line, the information inputting method further comprising the step of:
(e) selectively generating the first input value in the message line according to a set of virtual parameters of the virtual object.

19. The information inputting method of claim 18, wherein the set of virtual parameters comprises an overlapping time of the virtual object and the first input key, when the overlapping time is larger than a default time value, the first input value is generated in the message line.

20. The information inputting method of claim 18, wherein the set of virtual parameters comprises a set of moving parameters of the virtual object corresponding to the first input key during a first time, when the set of moving parameters complies with a default key-press condition, the first input value is generated in the message line.
